(19) United States
(12) Patent Application Publication
(10) Pub. No.: US 2019/0044154 A1
(43) Pub. Date: Feb. 7, 2019

(54) METHOD OF MANUFACTURING NANOCATALYST FOR FUEL CELL ELECTRODE

(71) Applicants: HYUNDAI MOTOR COMPANY, Seoul (KR); KIA MOTORS CORPORATION, Seoul (KR); Korea Advanced Institute of Science and Technology, Daejeon (KR)

(72) Inventors: Youjung SONG, Uiwang-si (KR); Won Jung KIM, Seoul (KR); Min Joong KIM, Daejeon (KR); Jeong Hoon LIM, Suseong-gu (KR); Sangjae LEE, Daejeon (KR); Yeon Sik JUNG, Daejeon (KR); Eun Ae CHO, Daejeon (KR)

(21) Appl. No.: 15/830,866

(22) Filed: Dec. 4, 2017

(30) Foreign Application Priority Data
Aug. 1, 2017 (KR) 10-2017-0097556

(51) Int. Cl. H01M 4/88; H01M 4/92; H01M 4/90

(52) U.S. Cl. CPC H01M 4/8846; H01M 4/8882; H01M 4/9075; H01M 4/925

(57) ABSTRACT

A method of manufacturing a nanocatalyst for a fuel cell electrode, capable of carrying metal catalyst nanoparticles on a polymer carrier without using a carbon carrier, includes steps of impregnating a conductive polymer carrier with a metal catalyst precursor solution; vacuum-drying the conductive polymer carrier; and heat-treating the conductive polymer carrier at a temperature of 160 to 300° C.

### CROSS-REFERENCE TO RELATED APPLICATION

This application is based on and claims the benefit of priority to Korean Patent Application No. 10-2017-0097556, filed on Aug. 1, 2017 in the Korean Intellectual Property Office, the entire disclosure of which is incorporated herein by reference.

### TECHNICAL FIELD

The present disclosure relates to a method of manufacturing a nanocatalyst for a fuel cell electrode, and more particularly to a method of manufacturing a catalyst capable of carrying metal catalyst nanoparticles on a polymer carrier without using a carbon carrier.

### BACKGROUND

A fuel cell is a device that directly converts chemical energy into electrical energy, which is economical because of its high energy converting efficiency. The fuel cell is eco-friendly because it does not emit any pollutants. However, the fuel cell has problems such as the high price of a noble metal catalyst, degradation of durability due to corrosion of a carbon carrier which occurs during driving of the fuel cell, and the like, which makes it difficult to commercialize fuel cells. In order to prevent such corrosion of the carbon carrier, attempts have been made to prevent corrosion by replacing a conventional carrier with a polymer having high chemical resistance. However, when a polymer carrier is used, there is a problem in that a conventional manufacturing method of carrying a noble metal catalyst on a carbon carrier cannot be applied as it is.

### SUMMARY

It is an aspect of the present disclosure to provide a method of manufacturing a nanocatalyst for a fuel cell electrode, which is capable of carrying a metal catalyst on a conductive polymer carrier in place of a carbon carrier.

Additional aspects of the present disclosure will be set forth in part in the description which follows and, in part, will be obvious from the description, or may be learned by practice of the disclosure.

In accordance with an embodiment of the present disclosure, a method of manufacturing a nanocatalyst for a fuel cell electrode includes the steps of impregnating a conductive polymer carrier with a metal catalyst precursor solution; vacuum-drying the conductive polymer carrier; and heat-treating the conductive polymer carrier at a temperature of 160 to 300° C.

Further, in accordance with an embodiment of the present disclosure, the metal catalyst may include at least one selected from a group including platinum (Pt), gold (Au), palladium (Pd), silver (Ag), ruthenium (Ru), and iridium (Ir).

Further, in accordance with an embodiment of the present disclosure, the metal catalyst precursor solution may be prepared by mixing the metal catalyst precursors in a ratio of 1:0.001 to 0.05 relative to the weight of a solvent.

Further, in accordance with an embodiment of the present disclosure, the solvent may include at least one selected from a group including benzene, toluene, xylene, naphthalene, anthracene, and benzopyrene.

Further, in accordance with an embodiment of the present disclosure, the conductive polymer carrier may include at least one selected from a group including polyaniline, poly(o-methoxyaniline), polypyrrole, poly(3,4-ethylenedioxythiophene), polythiophene, poly(p-phenylene), poly(3-hexylthiophene-2,5-diyl), poly(3-methylthiophene), and poly(p-phenylenevinylene).

Further, in accordance with an embodiment of the present disclosure, the conductive polymer carrier may further include polyethylene oxide.

Further, in accordance with an embodiment of the present disclosure, the step of vacuum-drying may be performed at a pressure of 0.01 atm or less for 5 to 20 minutes.

Further, in accordance with an embodiment of the present disclosure, the step of heat-treating may be performed for 30 minutes to 2 hours under an argon (Ar) atmosphere.

### BRIEF DESCRIPTION OF THE DRAWINGS

The above and other objects, features and advantages of the present disclosure will become more apparent to those of ordinary skill in the art by describing in detail exemplary embodiments thereof with reference to the accompanying drawings, in which:

FIG. 1 is a view illustrating processes for manufacturing a nanocatalyst for a fuel cell electrode according to an aspect of the present disclosure;

FIGS. 2 and 3 are photographs showing an aggregation phenomenon of carried metal catalyst particles;

FIG. 4 is a graph showing a result of thermogravimetric analysis of a conductive polymer carrier carrying metal catalyst nanoparticles;

FIG. 5 is a photograph showing the solubility test of platinum precursors according to a solvent; and

FIGS. 6 and 7 are TEM and SEM photographs of PEDOT:PSS+PEO blend films carrying platinum nanoparticles.

### DETAILED DESCRIPTION

Like reference numerals refer to like elements throughout the specification. This specification does not describe all the elements of the embodiments, and duplicate contents of the general contents or embodiments in the technical field of the present disclosure will be omitted.

The expression “a part includes an element” means that the part may further include other elements as well, rather than excluding other elements unless specifically stated otherwise.

The singular forms “a,” “an,” and “the” include plural referents unless the context clearly dictates otherwise.

In each step, an identification sign is used for the convenience of explanation, and the identification sign does not describe the order of each step, and each step may be performed differently from the order specified unless explicitly stated in the context.

Fuel cells are environmentally friendly and have high energy efficiency, but they have problems that make them difficult to commercialize. One of the problems is corrosion of commonly used carbon-based carriers. In order to solve this problem, a variety of alternative carriers have been studied. In addition to being electrochemically stable, these alternative carriers must have high electrical conductivity and a wide surface area for catalytic activity. Recently, metal catalyst particles are carried on a conductive polymer which is inexpensive and has an oxidation-reduction activity together, with a carbon carrier.

In carrying a metal catalyst on a conventional carbon carrier, a conductive polymer carrier has been used together with a carbon carrier. However, there has been a problem in that the conductive polymer carrier structure is collapsed or carbonized in a heat treatment step together with the limitation that carbon carrier corrosion cannot be solved.

Generally, there are three methods of carrying the metal catalyst nanoparticles on a carrier: electroplating, chemical reduction through a reducing agent, and heat treatment.

In the case of electroplating, it is necessary to consider the electrical conductivity of the carrier and the chemical reaction with the electrolyte, and the aggregation or coarsening of the metal nanoparticles may occur, so that the size of the carried catalyst particles is relatively large and the activity is decreased.

When the chemical reduction method is used, the conductive polymer in a film form must be dissolved in a solvent, and the physical properties of the polymer may change due to changes in pH.

Therefore, in the present disclosure, the metal catalyst is supported on the conductive polymer through the heat treatment. However, the following two problems arise in applying the heat treatment of the conventional manufacturing method carried on the carbon carrier as it is.

First, unlike the heat treatment of a metal/carbon catalyst in which precursors and carbon carriers are homogeneously mixed in a conventional powder or solution form, in the present invention in which the carbon carrier is not used, the conductive polymer and the metal catalyst precursor cannot be used in the form of a powder or solution.

Second, the heat treatment method of 400° C. or higher used for the conventional carbon-based carrier cannot be used because of the thermal stability of the conductive polymer carrier.

Accordingly, the present inventors have overcome the above problems by impregnating the conductive polymer carrier with a solution in which metal catalyst nanoparticles are dissolved, and then carrying it through vacuum-drying and low-temperature heat treatment, thereby completing the present disclosure.

According to the present disclosure relating to a method of carrying metal catalyst nanoparticles on a conductive polymer carrier, after the metal catalyst precursor solution is dried in a vacuum, metal catalyst nanoparticles of uniform particle size can be carried on the conductive polymer with high dispersion through heat treatment at a low temperature.

Hereinafter, a method of manufacturing a nanocatalyst according to the present disclosure will be described with reference to the accompanying drawings.

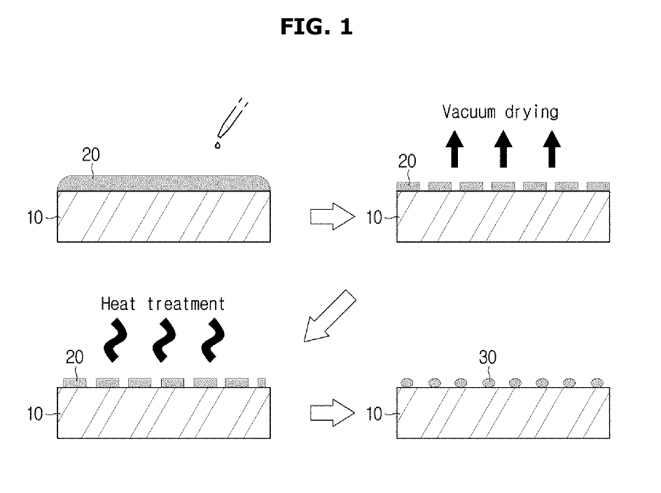

FIG. 1 is a view illustrating processes for manufacturing a nanocatalyst for a fuel cell electrode according to the present disclosure.

A method of manufacturing a nanocatalyst for a fuel cell electrode according to an embodiment of the present disclosure includes a step of impregnating a conductive polymer carrier 10 with a metal catalyst precursor solution 20, a step of vacuum-drying the conductive polymer carrier 10, and a step of heat-treating the conductive polymer carrier 10 at a temperature of 160 to 300° C.

The metal catalyst may include at least one selected from a group including platinum (Pt), gold (Au), palladium (Pd), silver (Ag), ruthenium (Ru), and iridium (Ir). The metal catalyst may be used by being dissolved in a solvent in the form of a precursor compound.

As described above, the metal catalyst precursor cannot be used in the form of a powder or a solution together with the conductive polymer. For this reason, the metal catalyst precursor may be impregnated on the conductive polymer carrier 10 in the form of a solution by being dissolved in a solvent to prepare a solution.

The solvent may include at least one selected from a group including benzene, toluene, xylene, naphthalene, anthracene, and benzopyrene which include aromatic hydrocarbons. The solvent may have a benzene ring and/or a methyl group, and may preferably be toluene with high solubility of the metal catalyst precursor.

The solvent should be excellent in not only the solubility of the metal catalyst precursor but also the wettability with the conductive polymer. Since the metal catalyst precursors are dissolved in the solvent and impregnated on the conductive polymer in the form of a solution, the dispersion degree of the metal catalyst precursors varies depending on the wettability of the conductive polymer and the solvent. In the case of the solvent having the benzene ring and/or the methyl group, the wettability with the conductive polymer is excellent, and thus the metal catalyst precursors can be evenly distributed on the conductive polymer.

The metal catalyst precursor solution 20 may be prepared by mixing the metal catalyst precursors in a ratio of 1:0.001 to 0.05 relative to the weight of a solvent. When the weight of the metal catalyst precursors relative to the weight of a solvent is less than 0.001, the concentration of the metal catalyst precursors contained in the solution becomes excessively low, and thus the active area of the metal nanocatalyst formed on the conductive polymer becomes small. On the contrary, when the weight of the metal catalyst precursors relative to the weight of a solvent is higher than 0.05, the solubility of the metal catalyst precursors soluble in the solvent is saturated, and uniform distribution cannot be expected in the impregnation on the conductive polymer. Preferably, the metal catalyst precursor solution 20 can be prepared at a ratio of 1:0.004 to 0.01 relative to the weight of a solvent.

The metal catalyst precursor solution 20 prepared by dissolving the metal catalyst precursors in a solvent is impregnated on the conductive polymer carrier 10.

Since the conductive polymer carrier 10 has a conductivity higher than a carbon-based carrier (2 to 5 S/cm), it is easy to transfer electrons and thus contributes to the improvement of the performance of a fuel cell. In particular, since the conductive polymer carrier 10 is electrochemically very stable under PEMFC operating conditions, the durability can be greatly improved by effectively inhibiting the corrosion occurring in the conventional carbon-based fuel cell carrier.

The conductive polymer carrier 10 may include at least one selected from a group including polyaniline, poly(o-methoxyaniline), polypyrrole, poly(3,4-ethylenedioxythiophene), polythiophene, poly(p-phenylene), poly(3-hexylthiophene-2,5-diyl), poly(3-methylthiophene), and poly(p-phenylenevinylene).

Preferably, PEDOT:PSS (poly(3,4-ethylenedioxythiophene):poly(styrene sulfonate)) (hereinafter, referred to as “PEDOT:PSS”) may be used as the conductive polymer carrier 10. PEDOT:PSS prepared from pure H2O is thermally stable and can be easily spin-coated, thus having excellent ease of processing, and is a commercialized conductive polymer.

Further, the conductive polymer carrier 10 may further include polyethylene oxide (hereinafter, referred to as “PEO”). PEO may be added to impart hydrophilicity of the conductive polymer and stability to water.

In addition, the conductive polymer carrier 10 may further include Nafion™. Nafion™ is a sulfonated tetrafluoroethylene-based fluoropolymer, and is a synthetic polymer called an ionomer because it has ionic properties that allow cation transfer.

The conductive polymer carrier 10 may be prepared in various forms by polymer blending the conductive polymers exemplified above. As an example, the conductive polymer carrier 10 may be in the form of a film, and may have a mesh pattern structure or an irregular micro pore structure depending on the preparing process.

Subsequently, the conductive polymer carrier 10 impregnated with the metal catalyst precursor solution 20 is vacuum dried to evenly distribute the metal catalyst precursors on the surface of the conductive polymer carrier 10.

The step of vacuum-drying of the conductive polymer carrier 10 may be performed for less for 5 to 20 minutes at a pressure of 0.01 atm.

Generally, when dried at normal pressure and temperature, the metal catalyst precursor solution 20 is dried from the edge of the conductive polymer carrier 10. On the surface of the initially dried conductive polymer the metal catalyst precursors are adsorbed at a low concentration, and on the last dried center surface the high concentration solution is dried, and thus the metal catalyst precursors are adsorbed at a high concentration, resulting in a difference in the concentration of the adsorbed metal catalyst precursors.

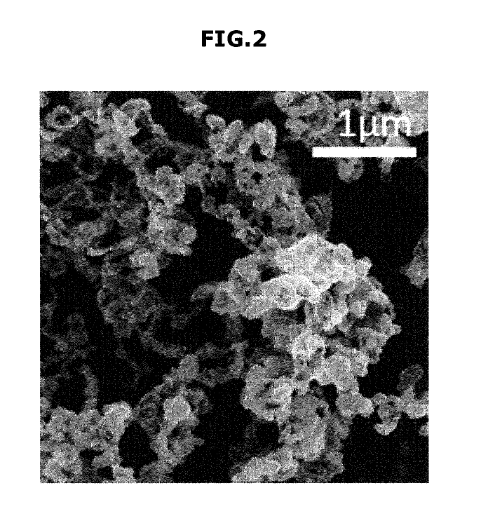

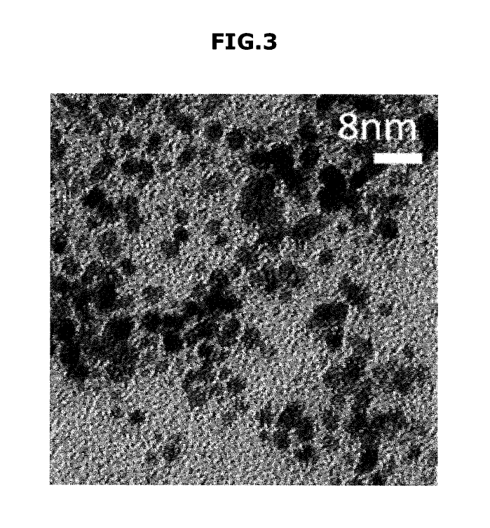

FIGS. 2 and 3 are photographs showing the aggregation phenomenon of carried metal catalyst particles.

Specifically, FIG. 2 shows a case of drying at normal temperature and pressure without using the solvent according to the present disclosure described above, and FIG. 3 shows a case of using the solvent according to the present disclosure, which is heat treated after drying at normal pressure. In a case where the aromatic hydrocarbon-containing solvent according to the present disclosure is not used and vacuum-drying is not performed, the difference in the concentration of the metal catalyst precursors is shown on the surface of the conductive polymer carrier 10, and the metal catalyst particles aggregate to a micrometer size after the heat treatment as shown in FIG. 2. In the case of using the solvent according to the present disclosure and vacuum-drying, the metal catalyst precursors are uniformly distributed on the surface of the conductive polymer. Even if the solvent according to the present disclosure is used, in the case of drying under normal pressure but not under vacuum, metal catalyst nanoparticles 30 having a nanometer size after heat treatment are carried, but an aggregation phenomenon of nanoparticles occurs. Such agglomeration of the metal catalyst nanoparticles 30 reduces the electrochemical active area of the catalyst and hinders gas diffusion.

Accordingly, the method of manufacturing a nanocatalyst for a fuel cell electrode according to an embodiment of the present disclosure vacuum dries the conductive polymer carrier 10, and the vacuum-drying may be performed for 5 to 20 minutes at a pressure of 0.01 atm or less. By conducting the drying under a pressure close to vacuum of 0.01 atm or less, through the effect of lowering the surface tension by lowering the vapor pressure of the solvent, wettability between the conductive polymer carrier 10 and the solvent is improved and the drying speed is improved, so that the metal catalyst precursors can be evenly distributed without any difference in concentration.

If the vacuum-drying of the conductive polymer carrier 10 is performed for less than 5 minutes, the solution on the surface may not be completely dried, and if the vacuum-drying is conducted for more than 20 minutes, a crack may be generated on the surface of the conductive polymer carrier 10.

The conductive polymer carrier 10 in which the metal catalyst precursors are uniformly distributed by vacuum-drying is subjected to heat treatment at 160 to 300° C. to reduce the metal catalyst precursors to nanoparticles.

In the present disclosure, since the metal catalyst nanoparticles 30 are carried on the conductive polymer carrier 10 without using a carbon carrier, the heat treatment method carried metal catalyst nanoparticles on the conventional carbon carrier cannot be used as described above. The heat treatment method at a temperature of 400° C. or more, which was used for the conventional carbon-based carrier, cannot be used because of the thermal stability of the conductive polymer carrier 10.

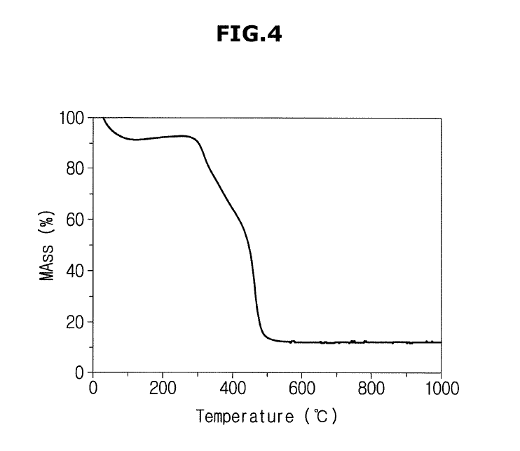

FIG. 4 is a graph showing the result of thermogravimetric analysis of the conductive polymer carrier 10 on which the metal catalyst nanoparticles 30 are carried.

Referring to FIG. 4, it is preferable that the heat treatment is performed at a temperature of 300° C. or less, since the conductive polymer carrier 10 starts to decompose beyond the thermal stability when the temperature is higher than from 300° C. Meanwhile, since the metal catalyst precursors are decomposed at 160° C. or higher and reduced to nanoparticles, it is preferable that the heat treatment is performed at a temperature of 160° C. or higher.

For the heat treatment, the conductive polymer carrier 10 may be heated to the above-mentioned temperature range at a temperature-raising rate of 3 to 7° C./min, and the temperature-lowering rate may be controlled to control the size of nanoparticles after the heat treatment. The size of the metal catalyst nanoparticles 30 is determined by the temperature-lowering rate after the heat treatment. After the nucleation of the nanoparticles occurs at the maintained temperature, when the temperature-lowering rate is fast, the reduction-carried nanoparticles are retained due to the rapid cooling effect. However, if the temperature-lowering rate is slow, nanoparticles having a size of 2 to 4 nm or more may be formed due to slow growth in the nuclei formed, and the distance between the metal catalyst nanoparticles 30 may be shortened to cause aggregation.

Further, the heat treatment step may be performed for 30 minutes to 2 hours under an argon (Ar) atmosphere to reduce the metal catalyst precursors. The precursors are not completely reduced or carried when the heat treatment is performed for less than 30 minutes, and when the heat treatment is performed for 2 hours or more, the precursors are reduced to a size of 2 to 4 nm larger than the nanoparticles and the aggregation phenomenon occurs.

Further, in order to increase the yield of the metal catalyst nanoparticles 30 during the heat treatment, a container for performing the heat treatment may be sealed to increase the partial pressure. For example, when performing a heat treatment in a crucible, it is preferable to cover the upper surface to increase the partial pressure.

Compared with the heat treatment method used for the conventional carbon carrier, the present disclosure can provide a fuel cell electrode which is capable of carrying the metal catalyst nanoparticles 30 without damaging the conductive polymer carrier 10 through the low-temperature heat treatment and is excellent in chemical durability and performance. In addition, since the process is simple, the productivity is excellent.

Hereinafter, embodiments of the present disclosure will be described in more detail. The following embodiments are for illustrating the disclosure, and the technical idea of the disclosure is not limited by these embodiments.

Preparation of Conductive Polymer Film

A blend of PEDOT (poly (3,4-ethylenedioxythiophene)) and PEO (poly (ethylene oxide)) was used.

0.03 g (molecular weight: 4,000 kg/mol) of PEO per 10 g of PEDOT:PSS solution (1.2 wt %) was added and mixed until sufficiently dissolved. The blend solution sufficiently melted with PEO was spread evenly on a silicon substrate and then spin-coated at a speed of 800 rpm for 40 seconds to prepare a uniform film and dried on a hot plate at 80° C. to produce a film having a thickness of 1 μm.

Then, a heat treatment was performed in a 150° C. vacuum oven for 6 hours in order to increase the stability of a PEDOT:PSS and PEO composite film to water through a crosslinking reaction between PEO and PSS.

Preparation and Impregnation of Metal Catalyst Precursor Solution

Platinum precursors (Pt acetylacetonate) were prepared using platinum (Pt) among metal catalysts.

A solution was prepared by dissolving the platinum precursors in a solvent to distribute the platinum precursors on the conductive polymer film. At this time, DI water, ethanol, isopropyl alcohol, acetone and toluene were tested as solvents since the dispersibility of the precursors varies depending on the wettability of a conductive polymer film and a solvent.

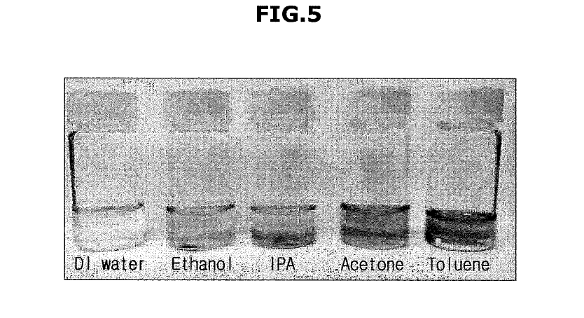

FIG. 5 is a photograph showing the solubility test of platinum precursors according to a solvent.

DI water, ethanol, and isopropyl alcohol were very low in solubility and could not be made into a solution. A platinum precursor solution was prepared by mixing 4 mg of platinum precursor with 1 mg of acetone and toluene as a solvent and sonicating for 2 minutes.

100 μl/cm2 of the platinum precursor solution was applied on the prepared PEDOT:PSS+PEO film.

Vacuum-Drying Step

Drying was performed for 10 minutes while maintaining 0.01 atm in a 20° C. vacuum oven.

As a result of the confirmation of the surface of the dried polymer film, the platinum precursor solution using acetone as a solvent still exhibited a precursor concentration difference between the initially dried surface and the later dried surface even under vacuum-drying conditions.

However, the platinum precursor solution using toluene as a solvent showed no difference in concentration on the surface of the polymer film after vacuum-drying. This is because aromatic hydrocarbons such as toluene have strong interaction with the PEDOT polymer film, which lowers the surface tension of the solvent.

Low Temperature Heat Treatment Step

The dried polymer film was placed in a crucible and covered with a stopper, and then the temperature was increased from normal temperature to 200° C. at a rate of 5° C./min and maintained for 1 hour under an argon (Ar) atmosphere.

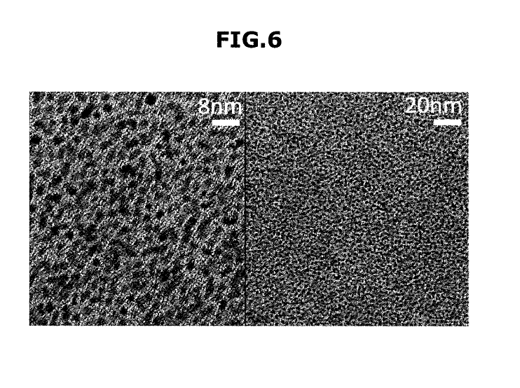

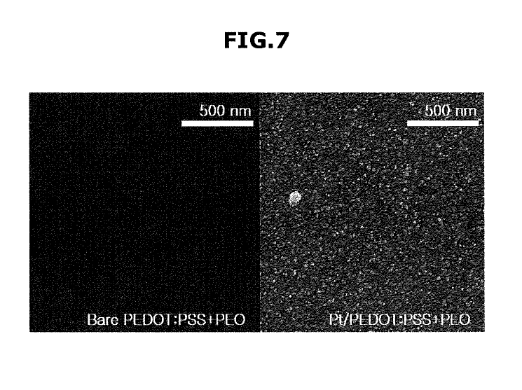

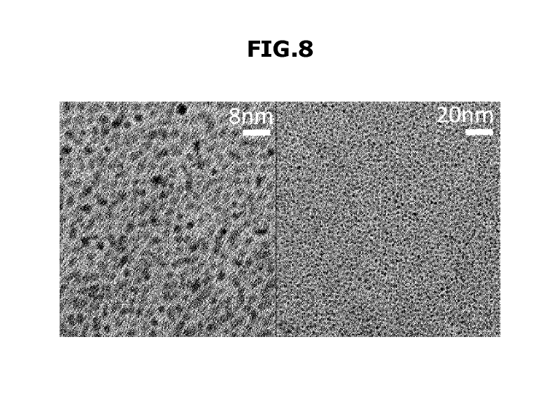

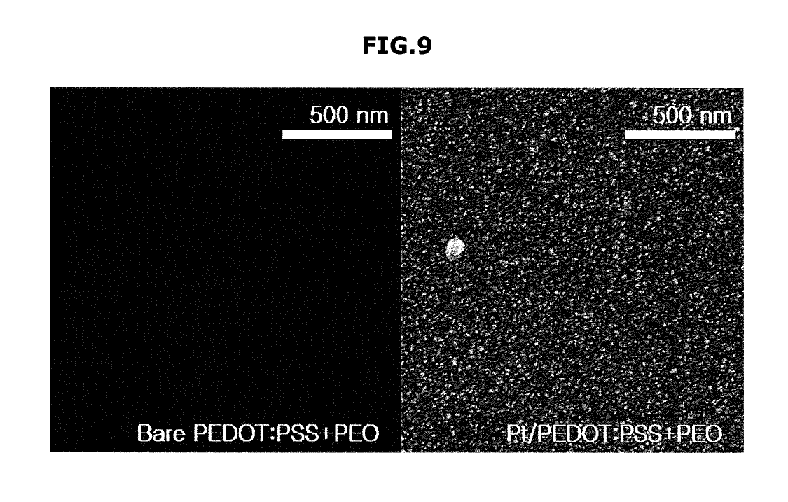

FIGS. 6 and 7 are a TEM image and an SEM image of PEDOT:PSS+PEO blend films carrying platinum nanoparticles, respectively. FIG. 7 shows a comparison of the polymer films before and after carrying the platinum nanoparticles.

Referring to FIGS. 6 and 7, as shown in the TEM image, it can be seen that the platinum nanoparticles are uniformly distributed. It was found that the size of the platinum nanoparticles was 2.5 to 4.0 nm, which was an average of 3.2 nm, and the standard deviation was 0.6 nm, indicating uniform distribution.

The following effects can be expected by a method of manufacturing a nanocatalyst for a fuel cell electrode according to an aspect of the present disclosure.

First, by uniformly distributing the metal catalyst precursors impregnated on a polymer carrier through vacuum-drying, aggregation or coarsening of the catalyst particles can be prevented. As a result, the catalyst has a high active area to prevent deterioration of the performance, and the amount of expensive noble metal catalyst used can be reduced.

In addition, since the polymer carrier is not exposed to a high-temperature, acidic or basic high-voltage environment by performing the heat treatment at a low temperature, it can be carried without damaging the polymer carrier, and the productivity of the production process is excellent.

As above, the embodiments disclosed with reference to the accompanying drawings have been described. It will be understood by those skilled in the art that the present disclosure may be practiced in other forms than the disclosed embodiments without departing from the spirit or essential characteristics of the present disclosure. The disclosed embodiments are illustrative and should not be construed as limiting.

1. A method of manufacturing a nanocatalyst for a fuel cell electrode comprising steps of:
depositing a metal catalyst precursor solution on a conductive polymer carrier;
vacuum-drying the conductive polymer carrier; and
heat-treating the conductive polymer carrier at a temperature of 160 to 300° C.,
wherein the step of vacuum-drying is performed at a pressure of 0.01 atm or less for 5 to 20 minutes,
wherein the metal catalyst precursor solution is prepared by mixing a metal catalyst precursor with a solvent in a precursor-to-solvent ratio of 0.001-0.05:1 by weight, and
wherein the solvent comprises at least one selected from a group including benzene, toluene, xylene, naphthalene, anthracene, and benzopyrene.

2. The method according to claim 1,
wherein a metal catalyst formed using the metal catalyst precursor solution comprises at least one selected from a group including platinum (Pt), gold (Au), palladium (Pd), silver (Ag), ruthenium (Ru), and iridium (Ir).

3. (canceled)

4. (canceled)

5. The method according to claim 1,
wherein the conductive polymer carrier comprises at least one selected from a group including polyaniline, poly(o-methoxyaniline), polypyrrole, poly(3,4-ethylenedioxythiophene), polythiophene, poly(p-phenylene), poly(3-hexylthiophene-2,5-diyl), poly(3-methylthiophene), and poly(p-phenylenevinylene).

6. The method according to claim 5,
wherein the conductive polymer carrier further comprises polyethylene oxide.

7. (canceled)

8. The method according to claim 1,
wherein the step of heat-treating is performed for 30 minutes to 2 hours under an argon (Ar) atmosphere.
